(19) United States
(12) Patent Application Publication
(10) Pub. No.: US 2021/0357913 A1
(43) Pub. Date: Nov. 18, 2021

(54) WALLET SERVER, WALLET SYSTEM, AND PROGRAM

(71) Applicant: TOYOTA JIDOSHA KABUSHIKI KAISHA, Toyota-shi (JP)

(72) Inventors: Yurika TANAKA, Yokosuka-shi (JP); Hideo HASEGAWA, Nagoya-shi (JP); Nozomu YOSHIOKA, Kasugai-shi (JP); Tsuyoshi TAKESHITA, Nagoya-shi (JP); Shoichiro SUZUKI, Tokyo (JP); Kohei ICHIHARA, Machida-shi (JP); Shota YAMAMOTO, Tokyo (JP); Junya CHIKANISHI, Tokyo (JP)

(73) Assignee: TOYOTA JIDOSHA KABUSHIKI KAISHA, Toyota-shi (JP)

(21) Appl. No.: 17/231,740

(22) Filed: Apr. 15, 2021

(30) Foreign Application Priority Data
May 13, 2020 (JP) 2020-084799

(51) Int. Cl. G06Q 20/36; G06Q 10/02; G06Q 50/30; G06Q 30/02; G08G 1/01

(52) U.S. Cl. CPC G06Q 20/367; G06Q 10/02; G08G 1/0125; G06Q 30/0224; G06Q 50/30

(57) ABSTRACT

A wallet server includes a processor provided with hardware. The processor acquires traffic information including a content related to a traffic condition in association with movement of a moving body that a user is on board from a traffic information server that provides the traffic information, weather information including a content related to weather in association with the movement of the moving body from a weather information server that provides the weather information, and payment settlement information including a content related to payment settlement of the user from a facility terminal installed in a facility, and calculates a reward for the user based on at least one of the payment settlement information, the traffic information, and the weather information.

### CROSS-REFERENCE TO RELATED APPLICATION

This application claims priority to Japanese Patent Application No. 2020-084799 filed on May 13, 2020, incorporated herein by reference in its entirety.

### BACKGROUND

### 1. Technical Field

The present disclosure relates to a wallet server, a wallet system, and a program.

### 2. Description of Related Art

Japanese Unexamined Patent Application Publication No. 2006-031601 (JP 2006-031601A) discloses a technology that receives a date of use from a customer, refers to a weather forecast and its accuracy ratio, calculates a discount rate on the date of use in accordance with the weather forecast and its accuracy ratio, and presents the customer with the discount rate.

### SUMMARY

There has been a demand for a technology that makes it easier for users to visit stores and other facilities and promotes the use of moving bodies even in bad weather, for example.

An object of the present disclosure is to provide a wallet server, a wallet system, and a program that can make it easier for the users to visit the stores and facilities, etc., and promote the use of the moving body even in bad weather, for example.

A wallet server according to the present disclosure includes a processor provided with hardware. The processor acquires at least one of traffic information, weather information, and payment settlement information. The traffic information is acquirable from a traffic information server that provides the traffic information and includes a content related to a traffic condition in association with movement of a moving body that a user is on board. The weather information is acquirable from a weather information server that provides the weather information and includes a content related to weather in association with the movement of the moving body. The payment settlement information is acquirable from a terminal installed in a store or a facility and includes a content related to payment settlement of the user. The processor calculates a reward for the user based on at least one of the payment settlement information, the traffic information, and the weather information acquired.

A wallet system according to the present disclosure includes a first device, a second device, a third device, and a fourth device. The first device includes a first processor that is provided with hardware and transmits traffic information including a content related to a traffic condition. The second device includes a second processor that is provided with hardware and transmits weather information including a content related to weather. The third device includes a third processor that is provided with hardware installed in a store or a facility and transmits payment settlement information including a content related to payment settlement. The fourth device includes a fourth processor that is provided with hardware, acquires the traffic information including the content related to the traffic condition in association with movement of a moving body that a user is on board from the first device, the weather information including the content related to the weather in association with the movement of the moving body from the second device, and the payment settlement information including the content related to the payment settlement of the user from the third device, and calculates a reward for the user based on at least one of the payment settlement information, the traffic information, and the weather information acquired.

A program according to the present disclosure causes a processor provided with hardware to execute: acquisition of traffic information including a content related to a traffic condition in association with movement of a moving body that a user is on board, from a traffic information server that provides the traffic information; acquisition of weather information including a content related to weather in association with the movement of the moving body from a weather information server that provides the weather information; acquisition of payment settlement information including a content related to payment settlement of the user from a terminal installed in a store or a facility; and calculation of a reward for the user based on at least one of the payment settlement information, the traffic information, and the weather information acquired.

According to the present disclosure, it is possible to make it easier for the users to visit the stores and facilities, etc., and to promote the use of the moving body even in bad weather, for example.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically showing a configuration of a wallet system according to an embodiment;

FIG. 2 is a diagram schematically showing a configuration of a wallet server according to the embodiment;

FIG. 3 is a diagram schematically showing a configuration of a payment service provider server according to the embodiment;

FIG. 4 is a diagram schematically showing a configuration of a user terminal according to the embodiment;

FIG. 5 is a diagram schematically showing a configuration of a vehicle according to the embodiment;

FIG. 6 is a diagram schematically showing a configuration of a store terminal according to the embodiment;

FIG. 7 is a diagram schematically showing a configuration of a vehicle management server according to the embodiment;

FIG. 8 is a diagram schematically showing a configuration of a traffic information server according to the embodiment;

FIG. 9 is a diagram schematically showing a configuration of a weather information server according to the embodiment;

FIG. 10 is a flowchart showing an example of a processing method by the wallet system according to the embodiment; and

FIG. 11 is a flowchart showing an example of a processing method by the wallet system according to the embodiment.

### DETAILED DESCRIPTION OF EMBODIMENTS

Hereinafter, embodiments of the present disclosure will be described below with reference to the drawings. In all the drawings of the following embodiments, the same or corresponding portions are designated by the same reference numerals. Further, the present disclosure is not limited to the embodiments described below. The components in the following embodiments also include those that can be easily replaced by those skilled in the art, or those that are substantially identical.

Wallet System

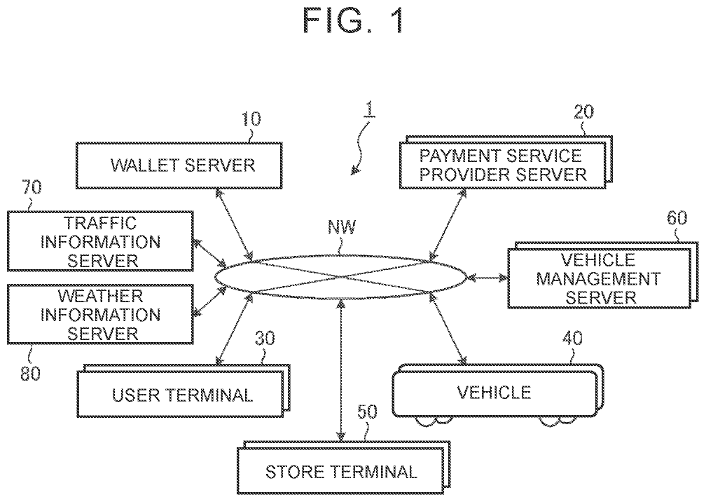

First, a wallet system according to an embodiment of the present disclosure will be described. As shown in FIG. 1, the wallet system 1 includes a wallet server 10, a payment service provider server 20, a user terminal 30, a vehicle 40, a store terminal 50, a vehicle management server 60, a traffic information server 70, and a weather information server 80.

The wallet server 10, the payment service provider server 20, the user terminal 30, the vehicle 40, the store terminal 50, the vehicle management server 60, the traffic information server 70, and the weather information server 80 are configured so as to be communicable with each other via a network NW. The network NW is composed of, for example, an Internet network and a mobile phone network. The network NW may include, for example, other communication networks such as a wide area network (WAN), a telephone communication network such as a mobile phone, and a wireless communication network such as Wi-Fi (registered trademark).

Wallet Server

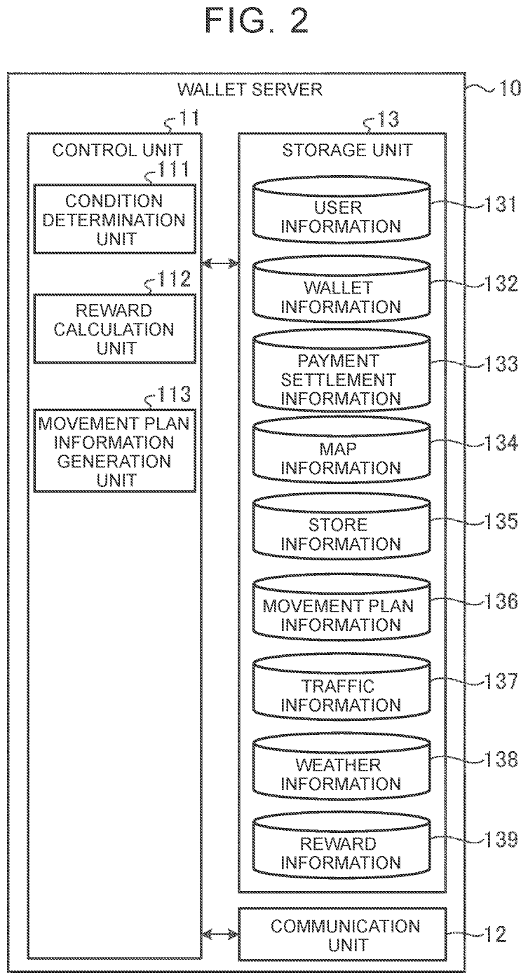

The wallet server 10 as a fourth device including a wallet server is a server for comprehensively managing the wallet system according to the present embodiment, and is managed by a wallet system administrator. As shown in FIG. 2, the wallet server 10 includes a control unit 11 as a fourth processor, a communication unit 12, and a storage unit 13.

Specifically, the control unit 11 is composed of a processor that is provided with hardware, such as a central processing unit (CPU), a digital signal processor (DSP), and a field-programmable gate array (FPGA), and a main storage unit, such as a random access memory (RAM) and a read-only memory (ROM). The storage unit 13 includes, for example, a recording medium selected from an erasable programmable ROM (EPROM), a hard disk drive (HDD), and a removable medium, etc. Examples of the removable media include disc recording media such as a universal serial bus (USB) memory, a compact disc (CD), a digital versatile disc (DVD), and a Blu-ray (registered trademark) disc (BD). The storage unit 13 can store an operating system (OS), various programs, various tables, and various databases, etc. The control unit 11 loads the program stored in the storage unit 13 into a work area of the main storage unit and executes the loaded program, and controls each component unit, etc. through execution of the program. Note that, the program may be a learned model generated through machine learning such as deep learning, for example. With the configuration above, the control unit 11 can realize functions of a condition determination unit 111, a reward calculation unit 112, and the movement plan generation unit 113. The details of the functions of the condition determination unit 111, the reward calculation unit 112, and the movement plan generation unit 113 will be described later.

The communication unit 12 as an information acquisition unit is composed of, for example, a local area network (LAN) interface board or a wireless communication circuit for wireless communication. The LAN interface board and the wireless communication circuit are connected to the network NW such as the Internet, which is a public communication network. The communication unit 12 connects to the network NW and communicates with the payment service provider server 20, the user terminal 30, the vehicle 40, the store terminal 50, the vehicle management server 60, the traffic information server 70, and the weather information server 80.

The storage unit 13 includes, for example, a recording medium such as an erasable programmable ROM (EPROM), a hard disk drive (HDD), and a removable medium. Examples of removable media include disc recording media such as a universal serial bus (USB) memory, a compact disc (CD), a digital versatile disc (DVD), and a Blu-ray (registered trademark) disc (BD). The storage unit 13 can store the operating system (OS), various programs, various tables, and various databases, etc. The storage unit 13 according to the present embodiment stores user information 131, wallet information 132, and payment settlement information 133 for each user of the wallet system. Further, the storage unit 13 stores map information 134 of various places, store information 135 including various information of stores, and movement plan information 136.

The user information 131 is information about the user who uses the wallet system. Examples of the user information 131 include, for example, a user ID, a password, a user name, user contact information (for example, an address, a telephone number, and an e-mail address), usage registration history, and information on payment means registered as deposit means, information on payment means registered as payment settlement means, and a password for making a payment settlement, of the user who has registered for use of the wallet system. The user ID and the password in the user information 131 are used during authentication processing such as logging in to the wallet server 10.

The wallet information 132 is information related to a wallet of the wallet system 1. The wallet is a virtual deposit and withdrawal account of electronic money. The wallet information 132 includes, for example, the user ID, balance of the electronic money, a deposit history of the electronic money, and a usage history of the electronic money.

The payment settlement information 133 is information related to payment settlement of the wallet system 1. The payment settlement information 133 includes the user ID, a payment settlement method used for making a payment settlement (e.g. payment by the electronic money (non-contact payment), payment by scanning, or payment by code), and payment settlement history.

The map information 134 is map information that can be notified to the user who uses the wallet system 1. Examples of the map information 134 include map data that can be output with a traveling route of the vehicle 40 that the user is on board and a walking route on which the user moves on foot, etc. being superimposed on the map data.

The store information 135 is information relating to the facilities and terminals of the stores that use the wallet system 1. Examples of the store information 135 include location information of the store facilities, information on products and services available at the store, information on business dates and times, and information on coupons and campaigns.

The movement plan information 136 is information related to a moving method and moving means, etc., when the user moves. The movement plan information 136 may include, for example, information such as a departure place, a destination, a departure time, an arrival time, a scheduled departure time, and a scheduled arrival time. The movement plan information 136 may include a boarding position that is a position for getting in a moving body such as the vehicle 40, a disembarking position that is a position for getting off from the vehicle 40, a boarding time and a disembarking time of the vehicle 40. Further, the movement plan information 136 may include a usage fee of the vehicle 40, etc., and a moving cost required for moving, etc. Further, the storage unit 13 stores traffic information 137, weather information 138, and reward information 139. The traffic information 137 includes various types of information related to a traffic condition collected by the traffic information server 70, and includes, for example, various types of information related to traffic obtained from a beacon installed on a road, for example. The weather information 138 includes various types of information related to the weather collected by the weather information server 80, and includes information in association with a wind direction, wind speed, and traveling direction and information on changes in road surface conditions due to rain and snow, etc. The weather information 138 includes information on an outside air temperature and a humidity. The outside air temperature and humidity include information on the actual measured temperature and measured humidity of the outside air, in addition to the air temperature and humidity during traveling. The reward information 139 includes information related to a reward for the user in regard to the use of the store and the vehicle 40, etc.

Payment Service Provider Server

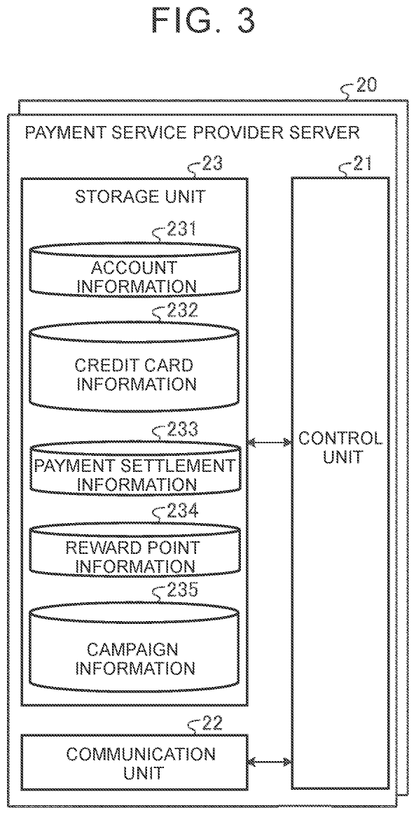

The payment service provider server 20 is a server for managing an account and a credit card of the user. The payment service provider server 20 is installed in a financial institution such as a bank, a Shinkin bank, a credit union, or a labor bank, or a credit card company. As shown in FIG. 3, the payment service provider server 20 includes a control unit 21, a communication unit 22, and a storage unit 23. The control unit 21, the communication unit 22, and the storage unit 23 are functionally the same as the control unit 11, the communication unit 12, and the storage unit 13, respectively.

The storage unit 23 stores account information 231, credit card information 232, payment settlement information 233, and reward point information 234 for each user of the wallet system 1. The account information 231 includes, for example, the name of the user, account number, account balance, and deposit and withdrawal history. The credit card information 232 includes, for example, the name of the user, credit card number, an expiration date of the credit card, usage limit amount, and card usage history. Examples of the payment settlement information 233 include the user ID, the payment settlement means, and the payment settlement history. Examples of the reward point information 234 include, for example, the name of the user, a unique user ID, the number of reward points associated with the account information or the credit card information. The storage unit 23 further stores campaign information 235 that is information on reward points returned and various campaigns held by a payment settlement service provider. Examples of the campaign information 235 include information on the reward point rate when a predetermined payment settlement method is used, information on an area where the campaign is carried out, and information on coupons provided to the user.

User Terminal

The user terminal 30 as a terminal constituting an information communication unit is a computer terminal operated by the user. Examples of the user terminal 30 include smartphones, mobile phones, tablet terminals, wearable computers, and personal computers held by the user, and car navigation systems mounted on vehicles. The user terminal 30 may be any terminal as long as the user terminal 30 can transmit and receive information to and from the wallet server 10.

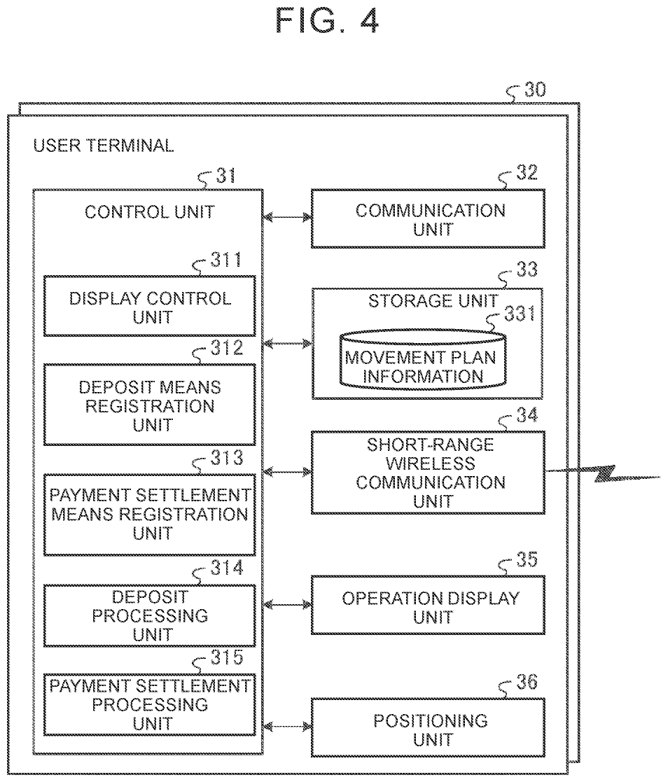

As shown in FIG. 4, the user terminal 30 as a fifth device includes a control unit 31, a communication unit 32, a storage unit 33, a short-range wireless communication unit 34, an operation display unit 35, and a positioning unit 36. The control unit 31, the communication unit 32, and the storage unit 33 are functionally the same as the control unit 11, the communication unit 12, and the storage unit 13 in the wallet server 10 shown in FIG. 2, respectively. As shown in FIG. 4, the control unit 31 as a fifth processor functions as a display control unit 311, a deposit means registration unit 312, a payment settlement means registration unit 313, a deposit processing unit 314, and a payment settlement processing unit 315.

The display control unit 311 controls contents to be displayed on an operation display unit 35 including a display. The display control unit 311 displays, for example, a member registration screen when the user registers as a member, a log-in screen when the user logs in to the wallet system, and a deposit screen when the user deposits money to the electronic money of the wallet, and a payment settlement screen when making a payment settlement on the operation display unit 35 to be operated based on user operations such as a touch operation and a flick operation by the user. In addition, the display control unit 311 transitions each screen based on operations of the user.

The deposit means registration unit 312 registers the deposit means for depositing money to the electronic money. The deposit means registration unit 312 transmits, to the wallet server 10, a deposit means registration request for registering a plurality of different payment settlement methods operated by a plurality of service providers as means of depositing money to the electronic money. Specifically, the plurality of different payment settlement methods operated by the plurality of service providers includes, for example, the bank account and the credit card. The control unit 11 of the wallet server 10 that receives the deposit means registration request from the deposit means registration unit 312 stores the payment settlement method included in the deposit means registration request in the storage unit 13 as the user information 131 and registers the payment settlement method as the deposit means.

The payment settlement means registration unit 313 registers various payment settlement means. The payment settlement means registration unit 313 transmits a payment settlement means registration request for registering the payment settlement means to the wallet server 10. The control unit 11 of the wallet server 10 that receives the payment settlement means registration request from the payment settlement means registration unit 313 stores the payment settlement method included in the payment settlement means registration request in the storage unit 13 as the user information 131 to register the payment settlement method as the payment settlement means. In addition, a payment settlement method may be registered instead of the payment settlement means.

The deposit processing unit 314 deposits money to the electronic money in the wallet. Specifically, the deposit processing unit 314 transmits, to the wallet server 10, a deposit request for depositing money to the electronic money using the payment settlement means registered as the deposit means. The control unit 11 of the wallet server 10 that receives the deposit request from the deposit processing unit 314 increments a balance of the electronic money in the wallet based on deposit amount information included in the deposit request. That is, the control unit 11 updates the wallet information 132 stored in the storage unit 13 in accordance with an increment in the balance of the electronic money in the wallet.

The payment settlement processing unit 315 executes payment settlement using the payment settlement method selected by the user. Specifically, the payment settlement processing unit 315 transmits a payment settlement request to the store terminal 50 via the short-range wireless communication unit 34 as the payment settlement means. The payment settlement processing unit 315 may transmit the payment settlement request to the store terminal 50 by reading a barcode or a QR code (registered trademark) displayed on the store terminal 50 using a camera, etc. of the user terminal 30 as the payment settlement means. The payment settlement processing unit 315 may transmit the payment settlement request to the store terminal 50 by causing a code reader, etc., of the store terminal 50 to read a barcode or a QR code (registered trademark) displayed on the user terminal 30 as the payment settlement means. The payment settlement request transmitted from the payment settlement processing unit 315 to the store terminal 50 may or may not include information indicating a payment settlement amount (hereinafter referred to as “payment settlement amount information”).

When the user makes payment settlement with the bank account or by the credit card, the payment settlement processing unit 315 transmits the payment settlement request to the wallet server 10 to make a payment settlement using any of the payment settlement means. The control unit 11 of the wallet server 10 that receives the payment settlement request from the payment settlement processing unit 315 transmits the payment settlement amount information included in the payment settlement request to the payment service provider server 20.

Further, when the user makes payment settlement by the electronic money, a control unit 51 of the store terminal 50, which will be described later, transmits the payment settlement request including the payment settlement amount information to the wallet server 10 via the network NW. The control unit 11 of the wallet server 10 that receives the payment settlement request from the store terminal 50 deducts the payment settlement amount from the balance of the electronic money in the wallet based on the payment settlement amount included in the payment settlement request. That is, the control unit 11 updates the wallet information 132 and the payment settlement information 133 stored in the storage unit 13 in accordance with the deduction in the balance of the electronic money in the wallet.

The storage unit 33 stores various screen data to be displayed on the operation display unit 35 by the display control unit 311. Further, the storage unit 33 temporarily stores the user information 131, the wallet information 132, the payment settlement information 133, the reward point information 234, and the campaign information 235, for example, as needed. Further, the user information 131 stored in the storage unit 33 includes user selection information that is information input by the user using the user terminal 30. Note that FIG. 4 shows a state in which the movement plan information 331 is stored. The movement plan information 331 is information related to the movement plan related to the user who holds the user terminal 30 among the movement plan information 136 in the wallet server 10.

The short-range wireless communication unit 34 has a communication function conforming to standards such as near field radio communication (NFC), Bluetooth (registered trademark) low energy (BLE), and infrared data association (IrDA). For example, when the user makes a payment settlement using the electronic money, the user terminal 30 performs short-range wireless communication with the store terminal 50 via the short-range wireless communication unit 34.

The operation display unit 35 is composed of, for example, a touch panel display, and has an input function for receiving an operation using a finger of the user or a pen, and a display function for displaying various types of information under the control of the display control unit 311.

The positioning unit 36 receives radio waves from a global positioning system (GPS) satellite and detects the location information of the user terminal 30. The control unit 31 transmits the location information of the user terminal 30 to the wallet server 10, the payment service provider server 20, or the store terminal 50 via the network NW.

### Vehicle

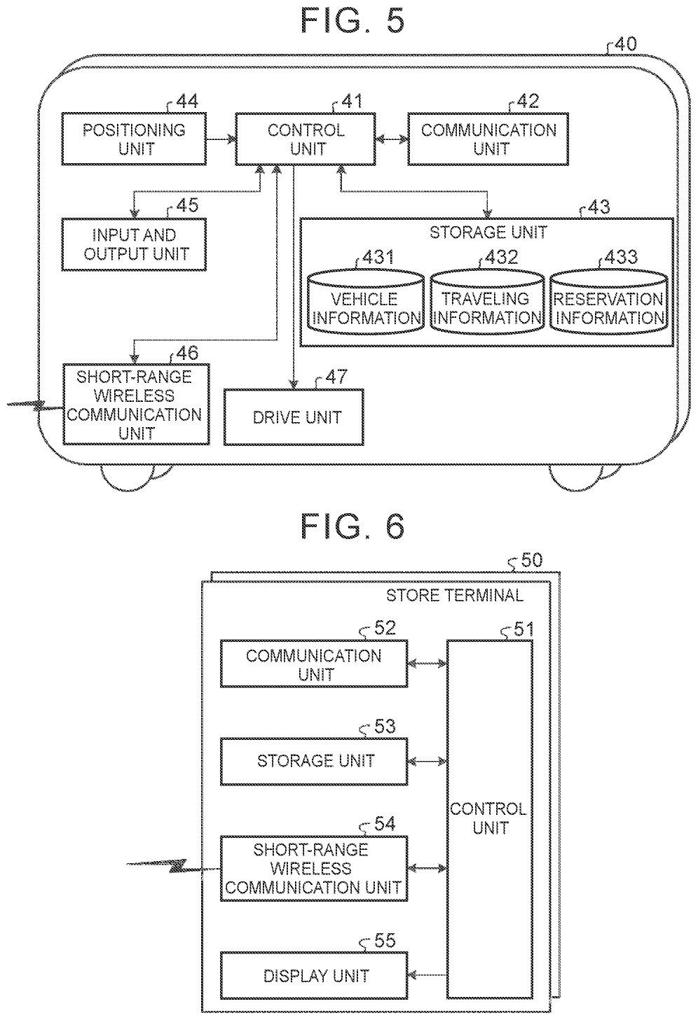

The vehicle 40 as a moving body is a vehicle that travels as a driver drives the vehicle, or an autonomously driven vehicle that is configured to be capable of autonomously driving in accordance with a traveling command issued to the vehicle 40. The services provided by the vehicle 40 include, for example, a car sharing service, a ride sharing service, a rental car service, a stay-type vehicle rental service, and an autonomous driving vehicle rental service. As shown in FIG. 5, the vehicle 40 includes a control unit 41 as a seventh processor, a communication unit 42, a storage unit 43, a positioning unit 44, an input and output unit 45, a short-range wireless communication unit 46, and a drive unit 47.

The control unit 41, the communication unit 42, the storage unit 43, the positioning unit 44, and the short-range wireless communication unit 46 are functionally the same as the control unit 11, the communication unit 12, and the storage unit 13 of the wallet server 10 and the positioning unit 36 and the short-range wireless communication unit 34 of the user terminal 30, respectively. The control unit 41 comprehensively controls the operation of various components mounted on the vehicle 40. The communication unit 42 as a communication terminal of the vehicle 40 is composed of, for example, a data communication module (DCM) that communicates with the wallet server 10 and the vehicle management server 60 by wireless communication via the network NW.

The storage unit 43 stores vehicle information 431, traveling information 432, and reservation information 433. The vehicle information 431 includes, but is not necessarily limited to, various types of information related to the vehicle 40 such as a state-of-charge of a battery (SOC), fuel level, current position, vehicle cabin condition, vehicle dimensional information, and exterior condition. The traveling information 432 includes, but is not necessarily limited to, various types of information related to movement of the vehicle 40, that is, traveling of the vehicle 40, which is measured and generated by the control unit 41 based on the information acquired from the positioning unit 44 and the drive unit 47, such as the location information, speed information, and acceleration information. The reservation information 433 is information related to a reservation generated by the wallet server 10 or the vehicle management server 60 based on, for example, the movement plan information 136 generated by the wallet server 10 and movement information input by the user terminal 30. The storage unit 43 stores the vehicle information 431, the traveling information 432, and the reservation information 433 in an updatable manner.

The location and the route of the vehicle 40 detected by the positioning unit 44 as a location information acquisition unit of the vehicle 40 are stored in the vehicle information 431 in a searchable manner as the location information and the travel route information in the traveling information. As a method for detecting the location of the vehicle 40, a method that combines light detection and ranging or laser imaging detection and ranging (LiDAR) system and a three-dimensional digital map may be adopted.

The input and output unit 45 is composed of a touch panel display and a speaker microphone, etc. The input and output unit 45 as output means is configured such that predetermined information can be notified externally by displaying characters and figures, etc. on the screen of the touch panel display or outputting voice from the speaker microphone, under the control by the control unit 41. Further, the input and output unit 45 as input means is configured such that the predetermined information can be input to the control unit 41 by the user by operating the touch panel display or outputting voice to the speaker microphone, etc.

The vehicle 40 according to the present embodiment has the positioning unit 44 and the input and output unit 45 as separate functions. However, the vehicle 40 may include an on-board navigation system that is provided with a communication function and that has both functions of the positioning unit 44 and the input and output unit 45, in place of the positioning unit 44 and the input and output unit 45.

The short-range wireless communication unit 46 has a communication function conforming to the standard such as NFC, BLE, or IrDA, and is provided at a predetermined position in the vehicle 40. When the user makes a payment using the electronic money, for example, the short-range wireless communication with the user terminal 30 is performed via the short-range wireless communication unit 46 by holding the user terminal 30 over the predetermined position.

The drive unit 47 is a drive unit that performs driving required for the vehicle 40 to travel. Specifically, the vehicle 40 includes an engine as a drive source.

The engine is configured to be able to generate electric power using an electric motor, for example, with driving by combustion of fuel. A rechargeable battery is charged using the generated electric power. Further, the vehicle 40 includes a drive transmission mechanism for transmitting a driving force of the engine and drive wheels for traveling, etc.

### Store Terminal

The store terminal 50 as a third device is installed in, for example, a store (member store) where the wallet system can be used. The store terminal 50 may be a server that also functions as a virtual store opened on the Internet, a so-called electronic commerce (EC) site.

As shown in FIG. 6, the store terminal 50 includes a control unit 51, a communication unit 52, a storage unit 53, a short-range wireless communication unit 54, and a display unit 55. The control unit 51 as a third processor, the communication unit 52, the storage unit 53, and the short-range wireless communication unit 54 are functionally the same as the control unit 11, the communication unit 12, the storage unit 13, and the short-range wireless communication unit 34, respectively. The display unit 55 is composed of, for example, a liquid crystal display (LCD) and an organic electroluminescence display (OLED), and displays information under the control of the control unit 51.

Vehicle Management Server

The vehicle management server 60 as a traveling management device has a general computer configuration communicable via the network NW, and manages traveling of the vehicle 40. In the present embodiment, various types of vehicle information 431 and traveling information 432 are supplied to the vehicle management server 60 from each vehicle 40 at a predetermined timing.

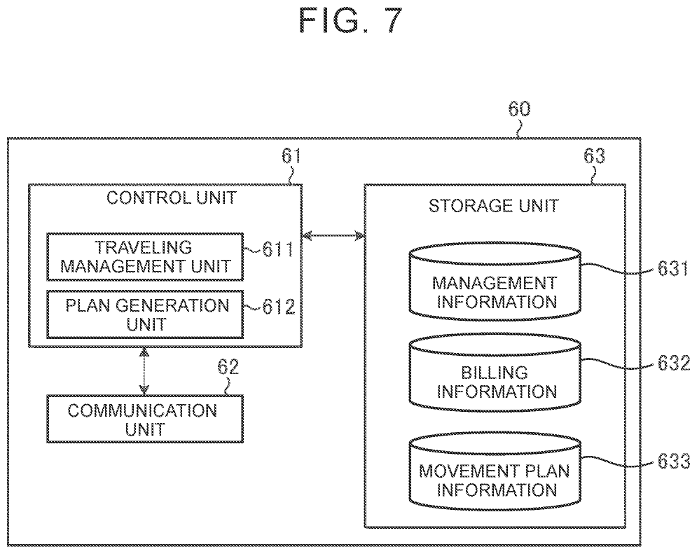

As shown in FIG. 7, the vehicle management server 60 as a sixth device includes a control unit 61, a communication unit 62, and a storage unit 63. The storage unit 63 can store an operating system (OS), various programs, various tables, and various databases, etc. The storage unit 63 stores management information 631. In addition, the storage unit 63 may store billing information 632 and movement plan information 633. The control unit 61, the communication unit 62, and the storage unit 63 are functionally the same as the control unit 11, the communication unit 12, and the storage unit 13, respectively. The control unit 61 as a sixth processor loads the program stored in the storage unit 63 into the work area of the main storage unit and executes the program, and controls each component, etc. through the execution of the program such that the function that satisfies a predetermined purpose can be realized. Note that, the program may be a learned model generated through machine learning such as deep learning, for example. With the configuration above, the control unit 61 can realize the function of a traveling management unit 611. The control unit 61 may be able to realize the function of a plan generation unit 612. Details of the functions of the traveling management unit 611 and the plan generation unit 612 will be described later.

The communication unit 62 connects to the network NW and communicates with the wallet server 10, the user terminal 30, and the vehicle 40. The communication unit 62 receives vehicle identification information and traveling information that are unique to the vehicle 40 and are included in the vehicle information 431 from each vehicle 40 and transmits a command signal to each vehicle 40. The vehicle identification information includes information for making each vehicle 40 individually identifiable. Further, the communication unit 62 transmits information to the user terminal 30 held by the user when the user uses the vehicle 40, and receives, from the user terminal 30, user identification information for identifying the user and various types of information.

The storage unit 63 includes management information 631 in which various data for managing the vehicle 40 are stored in a searchable manner. In the management information 631, vehicle specific information of the vehicle information 431 and the traveling information 432 are stored in association with each other. In the management information 631, the user ID and various types of information (hereinafter also referred to as user selection information) transmitted from the user terminal 30 and input or selected by the user may be stored in association with each other.

Traffic Information Server

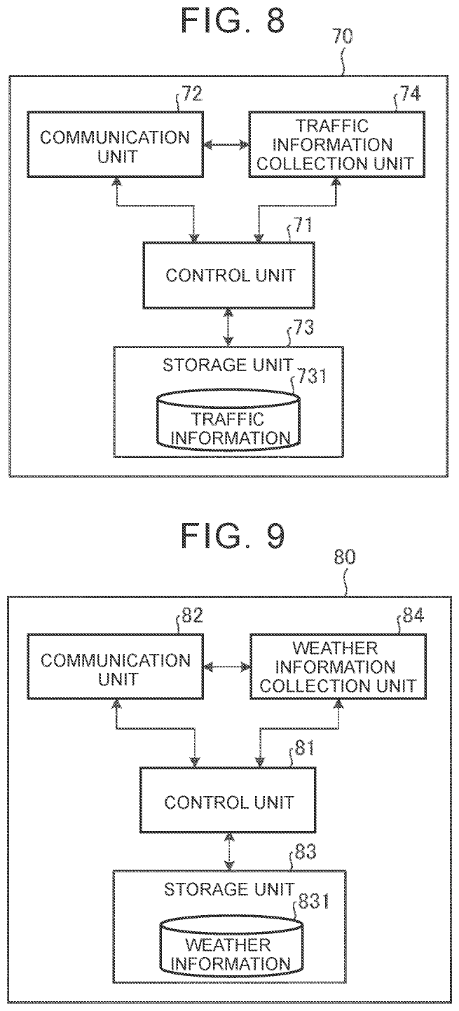

The traffic information server 70 collects traffic information including a content related to the traffic condition on the road and acquires information such as traffic on the road to distribute traffic information 731. As shown in FIG. 8, the traffic information server 70 as a first device includes a control unit 71, a communication unit 72, a storage unit 73, and a traffic information collection unit 74. The control unit 71 as a first processor, the communication unit 72, and the storage unit 73 are functionally the same as the control unit 11, the communication unit 12, and the storage unit 13, respectively. The storage unit 73 stores the traffic information 731.

The communication unit 72 connects to the network NW and communicates with the beacon or wallet server 10 that acquires the traffic information. The communication unit 72 transmits the traffic information to the wallet server 10. The information transmitted by the communication unit 72 is not limited to the information above.

The traffic information collection unit 74 collects the traffic information from, for example, the beacon installed on a road, etc., via the communication unit 72. The traffic information collected by the traffic information collection unit 74 is stored in the traffic information 731 stored in the storage unit 73 in a searchable manner. Note that, the traffic information collection unit 74 may further include a storage unit. Further, the traffic information collection unit 74 may be configured separately from the control unit 71, the communication unit 72, and the storage unit 73.

Weather Information Server

The weather information server 80 is a server installed in an organization that collects weather information, such as the Japan Meteorological Agency or a service provider that provides a weather information distribution service, and distributes weather information 831. As shown in FIG. 9, the weather information server 80 as a second device includes a control unit 81, a communication unit 82, a storage unit 83, and a weather information collection unit 84. The control unit 81 as a second processor, the communication unit 82, and the storage unit 83 are functionally the same as the control unit 11, the communication unit 12, and the storage unit 13, respectively. The storage unit 83 stores the weather information 831.

The communication unit 82 connects to the network NW, communicates with the wallet server 10 that acquires the weather information, and transmits the weather information to the wallet server 10. Note that, the information transmitted by the communication unit 82 is not limited to the information above.

The weather information collection unit 84 collects weather information from, for example, meteorological observation instruments installed in various places via the communication unit 82. The weather information collected by the weather information collection unit 84 is stored in the weather information 831 stored in the storage unit 83 in a searchable manner. Note that, the weather information collection unit 84 may further include a storage unit. Further, the weather information collection unit 84 may be configured separately from the control unit 81, the communication unit 82, and the storage unit 83.

The weather information server 80 may transmit the weather information indicating a traveling period and the weather of a traveling place included in the traveling history of the vehicle 40 to the wallet server 10 in response to a request from the wallet server 10. In this case, the weather information collection unit 84 may acquire the weather information 831 based on traffic congestion information used in other transportation systems and weather information used in a meteorological system. The weather information 831 includes information related to the wind direction, the wind speed, and the traveling direction and information on changes in the road surface conditions due to rain and snow, etc. The outside air temperature and the humidity include information on the actual measured temperature and measured humidity of the outside air, in addition to the air temperature and the humidity during traveling.

Wallet Server Processing Method

Next, a processing method in the wallet system 1 will be described. In the following description, information is transmitted and received via the network NW. The description of transmission and reception via the network NW will be omitted.

Further, when information is transmitted from each payment service provider server 20, each user terminal 30, each vehicle 40, and each store terminal 50, the information is transmitted in association with the identification information to identify the payment service provider server 20, the user terminal 30, the vehicle 40, and the store terminal 50. However, the description thereof will also be omitted.

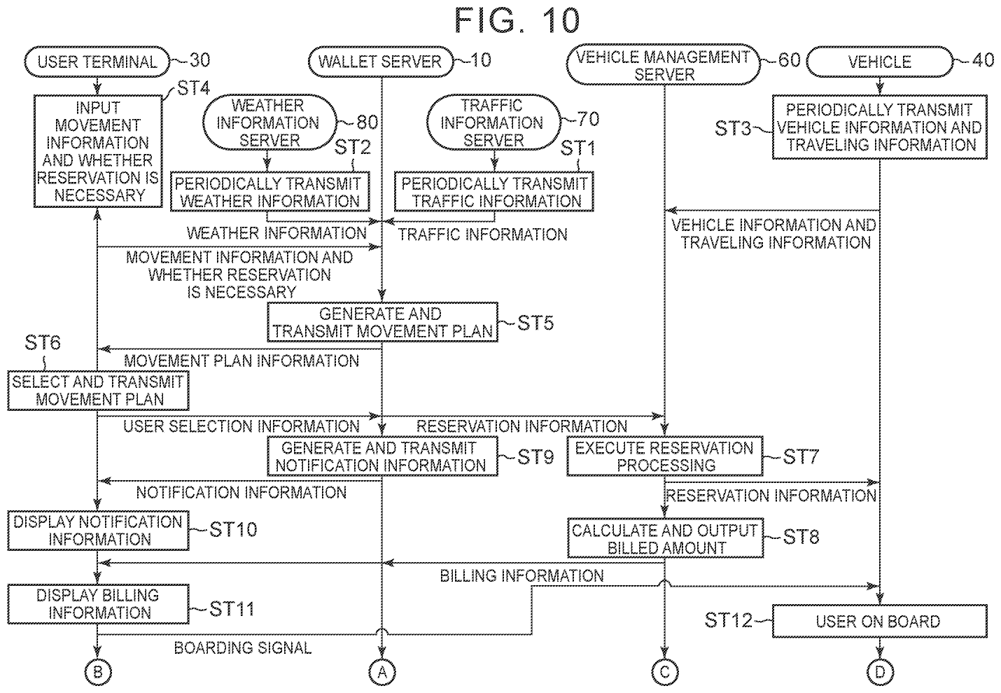

As shown in FIG. 10, first, in step ST1, the traffic information server 70 periodically or timely transmits the traffic information 731 to the wallet server 10. The received traffic information 731 in the wallet server 10 is stored in the storage unit 13 as the traffic information 137. In step ST2, the weather information server 80 periodically or timely transmits the weather information to the wallet server 10. The received weather information 831 in the wallet server 10 is stored in the storage unit 13 as the weather information 138. In step ST3, each vehicle 40 periodically or timely transmits the vehicle information 431 and the traveling information 432 to the vehicle management server 60. In the vehicle management server 60, the vehicle information 431 and the traveling information 432 are stored in the storage unit 63 as the management information 631. The above steps ST1, ST2, and ST3 are executed independently of each other, and the order of execution is not specifically limited.

Next, in step ST4, the user inputs the movement information using the user terminal 30. The movement information includes the information such as the departure place, the destination, a purpose of movement, the vehicle 40 to be boarded, and the boarding position and the disembarking position to and from the vehicle 40. The user further inputs whether reservation of the vehicle 40 is necessary using the user terminal 30. The reservation above means a reservation for using the vehicle 40 owned by a service provider or other owners that provide a car sharing service or a rental car service. When the vehicle 40 owned by the user is used, the reservation processing may be skipped. In the following description, a case where the vehicle 40 is reserved will be described. The movement information and information on whether reservation is necessary that are input to the user terminal 30 are transmitted to the wallet server 10.

In step ST5, the control unit 11 of the wallet server 10 that has acquired the movement information and the information on whether the reservation is necessary causes the movement plan generation unit 113 to generate at least one movement plan based on the movement information, and stores the generated movement plan information 136 in the storage unit 13. The control unit 11 transmits the movement plan information 136 to the user terminal 30 that has transmitted the movement information via the communication unit 12. The movement plan can also be generated by the plan generation unit 612 in the control unit 61 of the vehicle management server 60. The movement plan generated by the plan generation unit 612 is stored in the storage unit 63 as the movement plan information 633, and then transmitted to the wallet server 10. Further, the control unit 61 may transmit the movement plan information 633 generated by the plan generation unit 612 to the user terminal 30 via the communication unit 62.

In step ST6, the user determines a desired movement plan from at least one movement plan received by the user terminal 30 and inputs the selected movement plan to the user terminal 30. The user selection information including the selected movement plan information is transmitted to the wallet server 10. The wallet server 10 transmits the user selection information to the vehicle management server 60. In addition to the movement plan information, the user selection information includes the reservation information such as information regarding a start and an end of the rental required for renting the vehicle 40 input to the user terminal 30 or selected using the user terminal 30 by the user. The user selection information may include information on items selected by the user and information such as a rental basic fee set for each user. The user selection information including the reservation information may be transmitted from the user terminal 30 to the vehicle management server 60. In addition to generating the movement plan in the wallet server 10, the user may create the movement plan using the user terminal 30 and transmit the generated plan to the wallet server 10. With the configuration above, a degree of flexibility in designing the movement plan can be improved.

In step ST7, the vehicle management server 60 executes the reservation processing of the vehicle 40 based on the movement plan information received from the wallet server 10. The reservation processing is processing of securing time and a location at which the user starts using the vehicle 40 and time and a location at which the user ends using the vehicle 40, for example, by the vehicle management server 60. The reservation information is generated through the reservation processing executed by the vehicle management server 60. The vehicle management server 60 transmits the generated reservation information to the vehicle 40. With the processing above, the user who needs to make a reservation can automatically reserve the vehicle 40 in an appropriate time slot by inputting the movement information and selecting the movement plan information. That is, in steps ST4 to ST7, for example, the user can automatically reserve the vehicle 40 at an appropriate time or in an appropriate time slot by make selections of the purpose of movement, that is, visiting the shop or a leisure activity such as golf or going on a trip, with the wallet server 10.

Next, in step ST8, the control unit 61 of the vehicle management server 60 causes the traveling management unit 611 to calculate a billed amount such as a usage fee of the vehicle 40 based on the reservation processing. The control unit 61 stores the billed amount calculated by the traveling management unit 611 in the storage unit 63 as the billing information 632. The control unit 61 transmits the calculated billing information to the wallet server 10 via the communication unit 62. The wallet server 10 stores the received billing information 632 with being included in the payment settlement information 133 in the storage unit 13, and transmits the received billing information 632 to the user terminal 30 that has transmitted the user selection information of the user who uses the vehicle 40.

In step ST9, the control unit 11 of the wallet server 10 reads the map information 134 from the storage unit 13 based on the movement plan information 136, and generates, as notification information, various types of information related to a store or a leisure facility (hereinafter referred to as the “store”) that can be associated with the movement plan information 136. The notification information is stored in the storage unit 13 with being included in the store information 135. Note that the notification information may be generated based on the traffic information 137 and the weather information 138 of the location related to the movement plan information 136. The control unit 11 transmits the generated notification information to the user terminal 30 that has transmitted the user selection information.

In step ST10, the user terminal 30 displays the received notification information on the operation display unit 35. With the processing above, the user can recognize various types of information related to the store that can be associated with the movement plan information 136. In step ST11, the user terminal 30 displays the received billing information 632 on the operation display unit 35. With the processing above, the user can recognize the usage fee of the vehicle 40 associated with the movement plan information 136.

After the processing above, when the user is on board the vehicle 40 in step ST12, the short-range communication between the short-range wireless communication unit 34 of the user terminal 30 and the short-range wireless communication unit 46 of the vehicle 40 is performed. The short-range communication transmits a boarding signal from the user terminal 30 to the vehicle 40, and boarding processing is executed in the vehicle 40. Note that, the boarding signal may be transmitted from the vehicle 40 to the user terminal 30, and the boarding processing may be executed by the user terminal 30. At least one of the control unit 31 of the user terminal 30 and the control unit 41 of the vehicle 40 flags boarding of the user. Boarding flag information may be transmitted from at least one of the user terminal 30 and the vehicle 40 to the wallet server 10. With the processing above, the wallet server 10 can receive information on the content indicating that the user who holds the user terminal 30 is on board the vehicle 40.

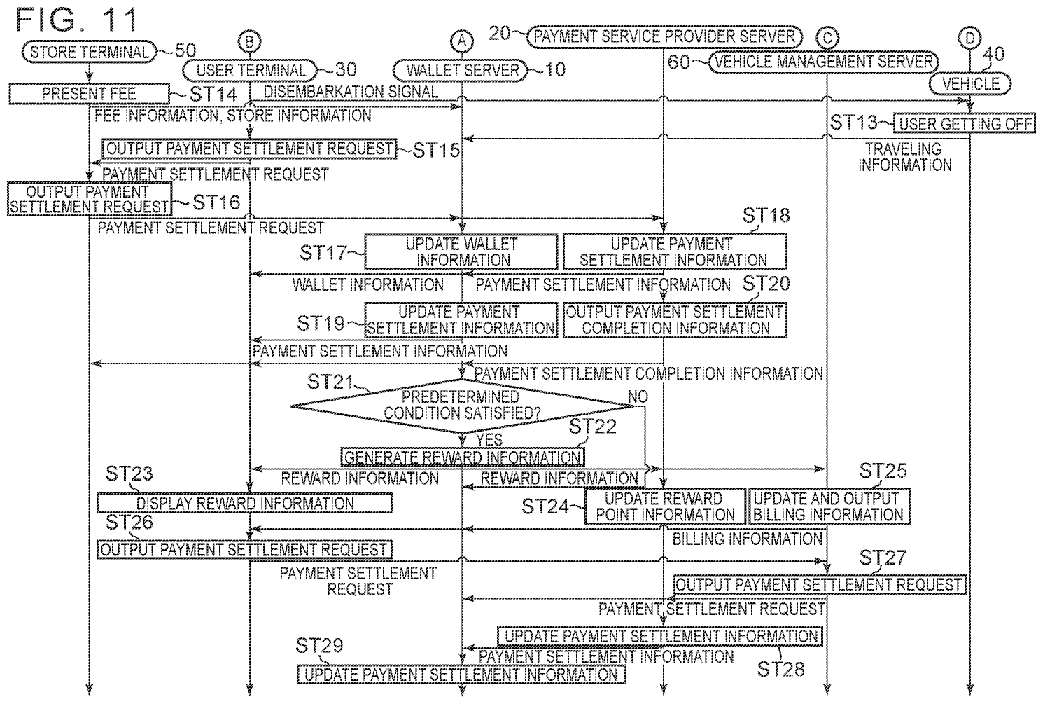

Next, as shown in FIG. 11, the user gets off the vehicle 40 in step ST13.

In this case, the user terminal 30 transmits a disembarkation signal to the vehicle 40 via the short-range communication by the short-range wireless communication units 34, 46, and disembarkation processing is executed in the vehicle 40. With the processing above, at least one of the control unit 31 of the user terminal 30 and the control unit 41 of the vehicle 40 cancels the flag for boarding of the user. The user gets off and enters the store.

After the processing above, the user who enters the store installed with the store terminal 50, which is a terminal provided in the store, hands a product to a clerk, receives a predetermined service from an employee, or uses a leisure facility. In step ST14, the store urges the user to pay the fee using the store terminal 50. The control unit 51 causes the display unit 55 of the store terminal 50 to display the fee. The store terminal 50 transmits the fee information and the store information to the wallet server 10.

After the step above, in step ST15, the payment settlement processing unit 315 of the user terminal 30 issues, to the store terminal 50, the payment settlement request for settling the payment settlement amount determined in step ST14 using the electronic money deposited in the wallet or displaying a predetermined code, for example. Subsequently, in step ST16, the control unit 51 outputs the payment settlement request acquired from the user terminal 30 to the wallet server 10 and the payment service provider server 20. Note that, the payment settlement request may be transmitted to only either of the wallet server 10 and the payment service provider server 20.

In step ST17, the control unit 11 of the wallet server 10 updates the wallet information 132 stored in the storage unit 13 in accordance with the payment settlement amount. The control unit 11 transmits the updated wallet information 132 to the user terminal 30. In step ST18, the control unit 21 of the payment service provider server 20 updates the payment settlement information 233 stored in the storage unit 23 in accordance with the payment settlement amount. The payment service provider server 20 transmits the updated payment settlement information 233 to the wallet server 10. In step ST19, the control unit 11 of the wallet server 10 updates the payment settlement information 133 stored in the storage unit 23 with the received payment settlement information 233. The control unit 11 transmits the updated payment settlement information 133 to the user terminal 30. Subsequently, in step ST20, the control unit 21 of the payment service provider server 20 transmits payment settlement completion information including the content indicating that the payment settlement processing is completed to the wallet server 10, the user terminal 30, and the store terminal 50. Note that, the control unit 11 of the wallet server 10 may execute all of steps ST17 to ST20. Further, the control unit 21 of the payment service provider server 20 may execute all of steps ST17 to ST20.

Next, in step ST21, the condition determination unit 111 of the wallet server 10 determines whether a predetermined condition is satisfied with respect to the information acquired in association with the movement of the user terminal 30 or the vehicle 40. The information acquired in association with the movement includes, for example, information selected from the payment settlement information 133, the map information 134, the store information 135, the traffic information 137, and the weather information 138 that are acquired as the user moves. The predetermined condition is set based on at least one of the payment settlement information 133, the traffic information 137, and the weather information 138. Further, the predetermined condition may be set based on the payment settlement information 133 and at least one of the traffic information 137 and the weather information 138. The predetermined condition may include a condition that the payment settlement amount of the payment settlement made using the user terminal 30 included in the payment settlement information 133 is equal to or more than a predetermined amount. The predetermined condition may be a preset condition regarding a combination of the payment settlement information 133 that is the information related to the payment settlement of the store or the facility and the traffic information 137 and the weather information 138 related to a movement route along which the user moves. The predetermined condition includes at least one condition, and a plurality of stages of conditions may be set, or a plurality of types of conditions may be set.

Here, as a specific example of the predetermined conditions, for example, the payment settlement information 133 includes “1,000 yen or more”, the traffic information 137 includes “traffic congestion”, and the weather information 138 includes “raining with its precipitation amount being 1 millimeter (mm) or more”. The plurality of stages of conditions means, with the traffic information 137 as an example, stages of “traffic congestion less than 1 kilometer (km)”, “traffic congestion 1 km or longer and less than 10 km”, and “traffic congestion 10 km or longer”. The plurality of types of conditions means, with the weather information 138 as an example, conditions such as “rain”, “snow”, “hail”, and “graupel”. The plurality of stages of conditions in the weather information 138 means conditions such as “raining with its precipitation amount being 1 mm or more and less than 10 mm” and “raining with its precipitation amount being 10 mm or more”. The conditions relating to the payment settlement information 133 include a condition that the store is a predetermined store and a condition related to a payment settlement time slot, in addition to the plurality of stages of conditions related to the payment settlement amount.

The information used for determining the predetermined condition may include any one of the payment settlement information 133, the traffic information 137, and the weather information 138. The information used for determining the predetermined condition may include information other than the payment settlement information 133, the traffic information 137, and the weather information 138, that is, for example, information on the purpose of movement of the user, and vehicle information and traveling information indicating the use of the vehicle 40. Specifically, a condition that the purpose of movement is “going on a trip” and information on a moving distance is “300 km or more” may be adopted as the predetermined condition. Further, the predetermined condition may include a condition based on information of the traveling distance of the vehicle 40.

When the condition determination unit 111 determines in step ST21 that the predetermined condition is satisfied (step ST21: Yes), the processing proceeds to step ST22. On the other hand, when the condition determination unit 111 determines that the predetermined condition is not satisfied (step ST21: No), the processing proceeds to the subsequent processing without executing step ST22.

In step ST22, the reward calculation unit 112 generates the reward information 139 based on the information acquired in association with the movement route. Here, the reward calculation unit 112 may calculate the reward such that as the various conditions included in the information acquired in association with the movement route become more severe, the reward also becomes higher. Specifically, for example, the reward calculation unit 112 can calculate the reward such that as the movement distance of the user becomes longer, the reward also becomes higher. In addition, the reward calculation unit 112 cam calculate the reward such that as a climate included in the weather information becomes more severe in terms of going out, the reward becomes higher.

As a specific example of calculation of the reward, for example, when the payment settlement information 133 includes “1,000 yen or more”, the reward calculation unit 112 can calculate the reward as 2%, for example, which is a predetermined ratio for the payment settlement amount included in the payment settlement information 133. That is, the reward calculation unit 112 can calculate the reward such that as the payment settlement amount included in the payment settlement information 133 becomes higher, the reward also becomes higher. The predetermined ratio for the payment settlement amount may also be changed in accordance with the payment settlement amount and the payment settlement amount in the past, etc.

When the predetermined conditions for the traffic information 137 are “traffic congestion less than 1 km”, “traffic congestion 1 km or longer and less than 10 km”, and “traffic congestion 10 km or longer”, the reward calculation unit 112 may calculate the reward in the case of “traffic congestion 1 km or longer and less than 10 km” to be higher than the reward in the case of “traffic congestion less than 1 km”, and may calculate the reward in the case of “traffic congestion 10 km or longer” to be even higher. That is, the reward calculation unit 112 can calculate the reward to be higher as the condition included in the traffic information 137 becomes more severe. In this case, as the traffic congestion becomes longer, the reward also becomes longer. With this processing, a stress imposed on the user by traffic congestion can be alleviated. When the reward is a discount amount of the payment settlement amount, the high reward indicates that the discounted amount is large. Further, a reverse calculation method may be adopted. The reward calculation unit 112 may calculate the reward to be lower as the condition included in the traffic information 137 becomes more severe. In this case, the user can be motivated to move so as to avoid the traffic congestion, which suppresses the traffic congestion.

Similarly, when the predetermined conditions for the weather information 138 are “raining with its precipitation amount being 1 mm or more and less than 5 mm”, “raining with its precipitation amount being 5 mm or more and 10 mm or less”, and “raining with its precipitation amount being 10 mm or more)”, the reward calculation unit 112 may calculate the reward in the case of “raining with its precipitation amount being 5 mm or more and 10 mm or less” to be higher than the reward in the case of “raining with its precipitation amount being 1 mm or more and less than 5 mm”, and may calculate the reward in the case of “raining with its precipitation amount being 10 mm or more” to be even higher. Further, when the weather information 138 includes information such as “rain”, “snow”, “hail”, and “graupel”, the reward calculation unit 112 can calculate the reward to be higher as the weather becomes more severe corresponding to the above. Consequently, because the reward becomes higher as the weather becomes worse, the user can be motivated to visit the store even in bad weather.

The storage unit 13 stores the reward information 139 generated by the reward calculation unit 112. The reward information 139 is information related to the reward for the user in regard to the use of the store and the vehicle 40, etc. The reward calculation unit 112 transmits the generated reward information 139 to the user terminal 30 with which the predetermined condition is satisfied via the communication unit 12. The display control unit 311 of the user terminal 30 may display the received reward information 139 on the operation display unit 35 (in step ST23). With the configuration above, the user who holds the user terminal 30 can recognize the information on the reward in regard to the use of the store and the use of the vehicle 40.

On the other hand, the reward calculation unit 112 transmits the generated reward information 139 to the payment service provider server 20 and the vehicle management server 60 via the communication unit 12. In step ST24, the payment service provider server 20 that receives the reward information 139 generates reward point information and coupon information (hereinafter collectively referred to as reward point information) associated with the user or the user terminal 30 based on the acquired reward information 139, and updates the reward point information 234. That is, the reward information generated in the wallet server 10 may be converted into the reward point information 234 in the payment service provider server 20.

In step ST25, the vehicle management server 60 that has received the reward information 139 updates the billing information 632 related to the vehicle 40 based on the acquired reward information 139. Specifically, processing is executed to, for example, deduct the discount amount included in the reward information 139 from the rental fee for the use of the vehicle 40, etc. Specifically, for example, the control unit 61 of the vehicle management server 60 executes the processing to deduct an amount corresponding to the traveling distance of 50 km from the rental fee for the entire traveling distance of the vehicle 40 based on the received reward information 139. After the processing above, the vehicle management server 60 generates the billing information after the deduction processing and updates the billing information 632 generated in step ST8. That is, the reward information generated in the wallet server 10 can be converted into a deduction amount from the rental fee in the vehicle management server 60. The control unit 61 of the vehicle management server 60 outputs the updated billing information 632 to the wallet server 10. The wallet server 10 transmits the acquired billing information 632 to the user terminal 30. The billing information 632 may be transmitted from the vehicle management server 60 to the user terminal 30.

In step ST26, the payment settlement processing unit 315 of the user terminal 30 transmits, to the vehicle management server 60, the payment settlement request for settling the payment settlement amount based on the acquired billing information using, for example, the registered credit card or the electronic money deposited in the wallet. Subsequently, in step ST27, the control unit 61 outputs the payment settlement request acquired from the user terminal 30 to the wallet server 10 and the payment service provider server 20. Note that, the payment settlement request may be transmitted to only either of the wallet server 10 and the payment service provider server 20.

In step ST28, the control unit 21 of the payment service provider server 20 updates the payment settlement information 233 stored in the storage unit 23 in accordance with the payment settlement amount. The payment service provider server 20 transmits the updated payment settlement information 233 to the wallet server 10. In step ST29, the control unit 11 of the wallet server 10 updates the payment settlement information 133 stored in the storage unit 13 in accordance with the acquired payment settlement information 233. Note that, the control unit 11 of the wallet server 10 may execute steps ST28 and ST29. Further, the control unit 21 of the payment service provider server 20 may execute steps ST28 and ST29. Further, the payment service provider server 20 may transmit the payment settlement completion information to the wallet server 10, the user terminal 30, and the vehicle management server 60.

The payment settlement processing for the rental fee of the vehicle 40, etc. may be executed when the user gets off the vehicle 40. Further, the amount of money at the time of payment settlement, that is, for example, the boarding fee when using the vehicle 40, may be an amount after deduction based on the past reward information 139 transmitted from the wallet server 10. With the processing above, the processing in the wallet system 1 according to the embodiment is completed.

According to the embodiment of the present disclosure described above, the use of the moving body such as the vehicle 40 can be promoted while making it easier for the user to visit the store even in bad weather or alleviating the traffic congestion. Further, the wallet server 10 can manage the information on the purpose of movement of the user and the information on a usage status of the vehicle 40 that is the moving body based on the movement plan information or the traveling information in cooperation with each other. With the configuration above, the information on the purpose of the user and the information on the usage status of the moving body can be accumulated in the wallet server 10 in association with each other. Note that, the information on the purpose of the user and the information on the usage status of the moving body may be accumulated in the vehicle management server 60 in association with each other.

Further, the wallet system 1 including the wallet server 10 according to the present embodiment can also be used for payment settlement made while the vehicle 40 is in operation when the user terminal 30 is the car navigation system mounted on the vehicle 40.

Recoding Media

According to the embodiment, a program capable of executing a processing method by the wallet server 10, the payment service provider server 20, the user terminal 30, and the vehicle management server 60 can be recorded in a recording medium that is readable by a computer or other machines or devices (hereinafter referred to as the computer). The computer functions as the control units of the wallet server 10 and the user terminal 30 as the computer is caused to read the program stored in the recording medium and execute the program. Here, the recording medium that is readable by the computer means a non-transitory storage medium that accumulates information such as data and programs through an electrical, magnetic, optical, mechanical, or chemical action and from which the computer can read the information. Examples of the recording media removable from the computer among the recording media above include, for example, a flexible disk, a magneto-optical disk, a compact disc read-only memory (CD-ROM), a compact disc rewritable (CD-R/W), a digital versatile disc (DVD), a Blu-ray disc (BD), a digital audio tape (DAT), a magnetic tape, and a memory card such as a flash memory. In addition, examples of the recording media fixed to the computer include a hard disk and a read-only memory (ROM). Further, a solid state drive (SSD) can be used as the recording medium removable from the computer or as the recording medium fixed to the computer.

Other Embodiments

Further, the term “unit” in the wallet server 10, the payment service provider server 20, the user terminal 30, the vehicle 40, the store terminal 50, the vehicle management server 60, the traffic information server 70, and the weather information server 80 according to the embodiment may be read as a “circuit”, etc. For example, the communication unit can be read as a communication circuit.

Further, the program to be executed by the wallet server 10, the payment service provider server 20, the user terminal 30, and the vehicle management server 60 according to the embodiment may be configured such that the program is stored in a computer connected to a network such as the Internet and executed by being downloaded via the network.

In the description of the flowchart in the present specification, the order of the processing between steps is clarified using expressions such as “first”, “after”, and “subsequently”. However, the order of processing required for realizing the embodiment is not always uniquely defined by those representations. That is, the order of processing in the flowchart described in the present specification can be changed within a consistent range.

Further effects and modifications can be easily derived by those skilled in the art. The broader aspects of the present disclosure are not limited to the particular details and representative embodiments shown and described above. Accordingly, various modifications may be made without departing from the spirit or scope of the general inventive concept as defined by the appended claims and their equivalents.

What is claimed is:

1. A wallet server, comprising
a processor provided with hardware, wherein
the processor
acquires at least one of traffic information, weather information, and payment settlement information, the traffic information being acquirable from a traffic information server that provides the traffic information and including a content related to a traffic condition in association with movement of a moving body that a user is on board, the weather information being acquirable from a weather information server that provides the weather information and including a content related to weather in association with the movement of the moving body, and the payment settlement information being acquirable from a terminal installed in a store or a facility and including a content related to payment settlement of the user, and
calculates a reward for the user based on at least one of the payment settlement information, the traffic information, and the weather information acquired.

2. The wallet server according to claim 1, wherein the processor calculates the reward based on the payment settlement information and at least one of the traffic information and the weather information.

3. The wallet server according to claim 1, wherein
the processor
acquires movement information including a content related to movement of the user input by the user from a user terminal held by the user, and
transmits, based on the movement information, reservation information of the moving body to a management server that manages the moving body that the user is to be on board.

4. The wallet server according to claim 1, wherein
the processor
acquires movement information including a content related to movement of the user input by the user from a user terminal held by the user, and
generates at least one movement plan information based on the movement information and transmits the generated movement plan information to the user terminal.

5. The wallet server according to claim 4, wherein the processor transmits, when the processor acquires from the user terminal the movement plan information selected by the user from the at least one movement plan information, reservation information of the moving body to a management server that manages the moving body that the user is to be on board based on the movement plan information selected by the user.

6. The wallet server according to claim 4, wherein the movement plan information includes information on a departure place, a destination, a boarding position to the moving body, and a disembarking position from the moving body of the user.

7. The wallet server according to claim 3, wherein
the processor
generates notification information related to a movement route included in the movement information, and
transmits the notification information to the user terminal.

8. The wallet server according to claim 1, wherein the processor calculates the reward when an item included in at least one of the payment settlement information, the traffic information, and the weather information satisfies a predetermined condition.

9. The wallet server according to claim 1, wherein the processor calculates the reward when a payment settlement amount included in the payment settlement information is a predetermined amount or more.

10. The wallet server according to claim 1, wherein the reward is a discount amount in regard to a usage fee of the moving body.

11. A wallet system, comprising:
a first device including a first processor that is provided with hardware and transmits traffic information including a content related to a traffic condition;
a second device including a second processor that is provided with hardware and transmits weather information including a content related to weather;
a third device including a third processor that is provided with hardware installed in a store or a facility and transmits payment settlement information including a content related to payment settlement; and
a fourth device including a fourth processor that is provided with hardware, acquires the traffic information including the content related to the traffic condition in association with movement of a moving body that a user is on board from the first device, the weather information including the content related to the weather in association with the movement of the moving body from the second device, and the payment settlement information including the content related to the payment settlement of the user from the third device, and calculates a reward for the user based on at least one of the payment settlement information, the traffic information, and the weather information acquired.

12. The wallet system according to claim 11, wherein the fourth processor calculates the reward based on the payment settlement information and at least one of the traffic information and the weather information.

13. The wallet system according to claim 11, further comprising a fifth device including a fifth processor that is provided with hardware and that transmits, when the user inputs movement information including the content related to the movement, the input movement information to the fourth device.

14. The wallet system according to claim 13, wherein
the fourth processor
acquires the movement information including the content related to the movement of the user input by the user from the fifth device, and
generates at least one movement plan information based on the movement information and transmits the generated movement plan information to the fifth device.

15. The wallet system according to claim 14, further comprising a sixth device including a sixth processor that is provided with hardware and manages the moving body, wherein the fourth processor transmits, when the fourth processor acquires the movement plan information selected by the user from the at least one movement plan information from the fifth device, reservation information of the moving body to the sixth device based on the movement plan information selected by the user.

16. The wallet system according to claim 13, further comprising a sixth device including a sixth processor that is provided with hardware and manages the moving body, wherein the fourth processor transmits, when the fourth processor acquires the movement information including the content related to the movement of the user input by the user from the fifth device, reservation information of the moving body to the sixth device based on the movement information.

17. The wallet system according to claim 13, wherein:
notification information related to a movement route included in the movement information is generated; and
the notification information is transmitted to the fifth device.

18. The wallet system according to claim 11, further comprising:
a sixth device including a sixth processor that is provided with hardware and manages the moving body; and
a moving body including a seventh processor that is provided with hardware and transmits traveling information related to traveling of the moving body to the sixth device.

19. The wallet system according to claim 11, wherein the fourth processor calculates the reward when an item included in at least one of the payment settlement information, the traffic information, and the weather information satisfies a predetermined condition.

20. A program that causes a processor provided with hardware to execute:
acquisition of traffic information including a content related to a traffic condition in association with movement of a moving body that a user is on board, from a traffic information server that provides the traffic information;
acquisition of weather information including a content related to weather in association with the movement of the moving body from a weather information server that provides the weather information;
acquisition of payment settlement information including a content related to payment settlement of the user from a terminal installed in a store or a facility; and
calculation of a reward for the user based on at least one of the payment settlement information, the traffic information, and the weather information acquired.
